(19) United States
(12) Patent Application Publication
(10) Pub. No.: US 2010/0031317 A1
(43) Pub. Date: Feb. 4, 2010

(54) SECURE ACCESS

(76) Inventors: Jeremy R. Mason, Ipswich (GB); Simon Howe, Bridgend (GB); Colin R. Paterson, Ipswich (GB); Richard Doyle, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/446,658

(22) PCT Filed: Oct. 11, 2007
(86) PCT No.: PCT/GB07/03856

§ 371 Date: Apr. 22, 2009

(30) Foreign Application Priority Data
Oct. 31, 2006 (GB) 0621684.0

(51) Int. Cl. H04L 29/06

(52) U.S. Cl. 726/3

(57) ABSTRACT

Secure access is provided to a resource hosted in a first domain. A first web server provides access to the resource. A second web server is provided in a second domain for receiving requests from a user for access to the resource. A browser is arranged for authentication and authorization for access to resources in the second domain and for forwarding requests from the user to the second web server. A reverse proxy is provided for publishing, with a resource identifier identifying the second domain, the resource to the second web server. The reverse proxy is arranged to forward to the first web server for access to the resource requests received from the second browser.

The invention relates to the field of network security and, in particular, has application to secure access to resources in a network.

In the following, authentication is used to denote verification of the identity of a person, program or device. Authorization is used to denote deciding if a person, program or device is allowed to have access to a resource (data, functionality or service). The invention has particular application to resources accessed via a network and identified by a universal resource locator (URI) or universal resource identifier (URI).

Benefit has been identified in opening up secure intranet resources, such as corporate applications to external users and also opening up secure access to external, internet-based resources to employees working via an organisation's private internal network. By opening up systems originally restricted to be accessed via a company intranet in which users and application both sit within the company's firewall for use by a wider user base, the significant investment made in internal corporate systems can be exploited to increase the return to the business. The single internal application can then serve both internal and external users and this allows the rationalisation of systems by removing the need for separate internal and external applications and by focussing on a single universal system for any particular function.

To maintain security and protect web-based applications from unauthorized access, each user in each class is required to log-on and be authenticated by an authentication and authorization server before access to the system is allowed. Successful authentication is marked by the issue, by the authentication and authorization server of a cookie to the user. All subsequent accesses by that user to the system are then accompanied by the cookie to demonstrate the identity of the user. However, a problem arises in trying to authenticate, for access to a web-based application, users operating in different domains.

When determining if the cookie is valid, a comparison of the domain attribute associated with the cookie is made with the Internet domain name of the web server on which the resource is hosted. If there is no tail match, then the cookie will not be sent.

“Tail matching” means that domain attribute is matched against the tail of the fully qualified domain name of the host. Conventionally, only hosts within a specified domain can set a cookie for that domain. The default value of domain is the host name of the server which generated the cookie.

For example, BT has developed a new Friends & Family (F&F) application. With Friends & Family customers can nominate 10 numbers of choice, which can be any combination of UK and mobile numbers, plus one international number. Customers will receive a discount on any calls made to these numbers. The F&F application enables customers (and advisors) to setup and manage the choice of numbers or request auto-update (where BT automatically selects the numbers).

In this example, F&F consumers operate in the “bt.com” domain and authenticate using bt.com credentials. These credentials are supplied to the authentication and authorization server for the application via a bt.com cookie. To access the resource, the consumer sends a request accompanied by a copy of the cookie issued for the domain in which the resource is hosted—i.e. the bt.com domain. There is a need to provide to a user authenticated in one domain, access to an application hosted through another domain.

In order for advisors to access secure resources in the internal “nat.bt.com” domain they need to be authenticated using corporate directory credentials. The corporate directory is a database of user information, for example implemented as lightweight directory access protocol (LDAP) directory services such as the Microsoft Active Directory.

Single sign-on (SSO) is a highly desirable mode of secure access that provides a user with access to the resources of multiple software systems requiring the user to authenticate only once, i.e. to one of the systems. SSO can greatly simplify and speed up access for users. Whereas SSO is known in providing access to resources within a single domain, there is a need to provide a cookie-based SSO for users to access securely resources in different domains, whilst minimising disruption to existing systems. Ideally, this is achieved without generating a plurality of cookies per user. The present invention provides access to web-based, e.g. intranet and internet systems or applications by users operating in different domains.

The invention provides a system for providing secure access to a resource hosted in a first domain, in which the first domain comprises a first web server for providing access to the resource; in which the system comprises: a second web server for operating in a second domain for receiving requests from a user for access to the resource; in which the system also comprises: a browser arranged in use to be authenticated and authorized to access resources in the second domain and to forward requests from the user to the second web server and a reverse proxy for publishing, with a resource identifier identifying the second domain, the resource to the second web server.

According to a preferred embodiment, the reverse proxy is arranged to forward to the first web server for access to the resource requests received from the second browser.

According to a preferred embodiment the request comprises a resource identifier specifying the second domain and the reverse proxy is arranged in use to replace the resource identifier received with the request with a resource identifier specifying the first domain.

According to a preferred embodiment the reverse proxy is a plug-in to the second server. According to a preferred embodiment the first domain comprises a policy for supporting access from the second domain. According to a preferred embodiment the policy is arranged to access user information from a database also accessible from the second domain. According to a preferred embodiment the policy is arranged to use user information also used by a policy in the second domain. According to a preferred embodiment the system comprises filter means for blocking access to the resource by a user in the second domain using a resource identifier identifying the first domain.

The invention also provides a reverse proxy for a second domain for providing secure access to a resource hosted in a first domain, in which the reverse proxy is arranged in use to: publish the resource in the second domain with a resource identifier identifying the second domain; receive a request specifying the resource identifier from a user in the second domain for access to the resource; replace in the request the received resource identifier with a resource identifier identifying the first domain; and forward the request to the first domain.

The invention also provides a method of securely accessing from a second domain a resource in a first domain, the method including the steps of: publishing the resource in the second domain with a resource identifier identifying the second domain.

The invention may also include receiving a request specifying the resource identifier from a user in the second domain for access to the resource; replacing in the request the received resource identifier with a resource identifier identifying the first domain; and forwarding the request to the first domain.

The invention may also include differentiating the resource identifier identifying the first domain from a third resource identifier identifying the first domain for access to the resource from the first domain. The invention may also include setting up a policy on the first domain to support access from the second domain.

According to preferred embodiments: the policy accesses user information from a database also accessed from the second domain; and/or the policy uses user information also used by a policy in the second domain.

The invention may also include blocking access to the resource using a resource identifier identifying the first domain by a user in the second domain.

Conventionally, a reverse proxy is called upon to perform one of the following functions:

to offload tasks from the web server, such as secure socket layer encryption and caching of static content;
to provide an additional layer of defence to protects a web servers in which it is plugged-in;
to distribute load to between several web servers.

The present invention identifies a novel role for the reverse proxy in providing access to remote resources.

To aid understanding of the invention, embodiments will now be described by way of example, with reference to the drawings in which:

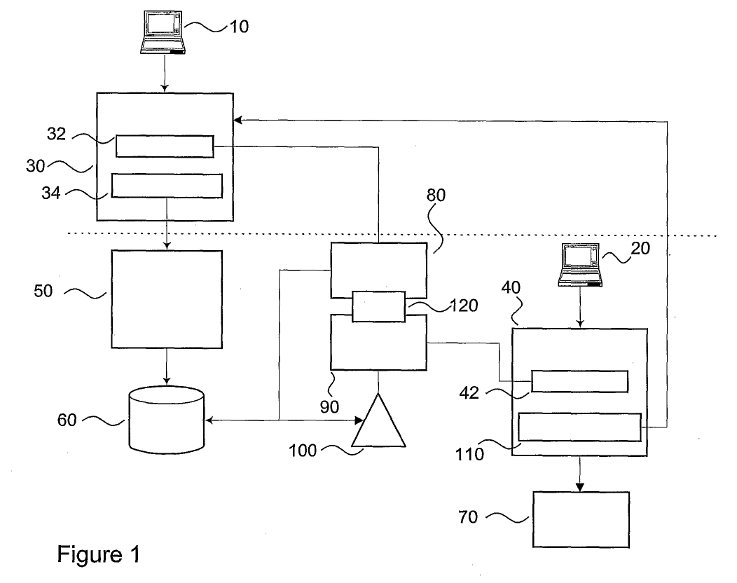

FIG. 1 shows a block diagram of a system for providing secure access to a resource according to an embodiment of the invention.

The invention will now be described in more detail with reference to FIG. 1. FIG. 1 shows a web based system supporting two users: represented by consumer browser 10 and advisor browser 20. Each browser provides access for the respective user (not shown) to a connected web server. Consumer browser 10 provides access for a consumer user to first web server 30. Advisor browser 20 provides access for an advisor user to second web server 40. First web server 30 provides access for the consumer to a web application, in the present embodiment the bt.com Friends and Family (F&F) application hosted on bt.com F&F web server 50. The bt.com F&F application has access to user data stored in bt.com database 60. In a similar arrangement, second web server 40 provides access to the advisor to a Customer Relationship Management (CRM) application hosted on CRM application server 70. Application servers 40, 50 and 70, together with database 60 and advisor browser 20 are located within a fire wall (represented in the FIGURE by a dotted line). The firewall protects the network internal to an organisation (shown below the dotted line in the FIGURE) from unauthorized access from the wider network (e.g. the world wide web) shown above the dotted line in the FIGURE. As the advisor and the advisor browser are located within the firewall, on the so-called “green side”, the advisor has access to the connected servers without needing to pass through the firewall. The consumer, on the other hand, is located outside of the fire wall on the so-called “red side” and access to the bt.com F&F web application is only obtainable via the organisation firewall.

Both consumer and advisor users need to log into their respective connected servers 30, 40 so as to obtain authentication and authorization for access to the protected resource (according to this embodiment the consumer requires access to the protected resource that is the bt.com F&F web application and the advisor requires access to the protected resource that is the CRM application). The consumer is authenticated and authorized in a conventional manner according to a bt.com authentication and authorization consumer policy by consumer policy server 80. In a similar fashion, the advisor is authenticated and authorized according to a nat.bt.com authentication and authorization employee policy by employee policy server 90. Authentication and authorization requests are forwarded to the respective policy server by a web agent plugged into the respective web server. Hence for consumer browser 10, first web server 30 comprises first Siteminder web agent 32 and for advisor browser 20, second web server 40 comprises second Siteminder web agent 42. Netegrity® SiteMinder is a commercially available access management system featuring policy-based authentication and authorization management and supporting single sign-on.

Consumer policy server 80 has access to bt.com database 60 which contains information on consumer users. Employee policy server 90 has access to corporate database 100 (for example a corporate active directory or CAD from Microsoft) which contains information on advisor users. According to the invention, consumer policy server 80 also has access to corporate database 100 for purposes of verification and authorization of requests received at bt.com web server 30 from the advisor.

In the secure access system discussed here, requests are made by the user as part of one or more sessions. A session is initiated by a user (not shown) submitting a request comprising a username identifying the user and an optional password. Before the session is set up, the username submitted with the request is forwarded to an authentication and authorization authority represented in FIG. 1 by policy server 80 and database 60 or policy server 90 and database 100, for the consumer and the advisor, respectively. Policy servers 80 and 90 authenticate the submitted username by checking it against authenticated usernames held in the respective database 60 or 100. Databases 60, 100 contain information (or “credentials”) on users and may each, for example, comprise an authentication lightweight directory access protocol (LDAP) server and an authorization LDAP server. Once the user has been authenticated, the web agent 32, 42, as the case may be, provides the user (consumer or advisor—not shown) with an encrypted cookie that contains information identifying the user. On receipt, the cookie is stored by the respective user's browser 10 or 20. With each subsequent communication from the user forming part of that session, the browser 10 or 20 sends a copy of the cookie. Each cookie received from the user's browser 10 or 20 by the respective web server 30 or 40 is forwarded to respective policy server 80 or 90 where it is decrypted so as to allow the user to be securely identified.

Once authenticated, the user (not shown) can request via browser 10 or 20 access to a protected resource, typically identified by a URI. Each request is accompanied by a copy of the cookie identifying the user. Web agent 32 or 42 operating on web server 30 or 40 sends the user cookie received from the user's browser to policy server 80 or 90 for validation. Policy server 80 or 90 decrypts the cookie to obtain the user's identity and validates the user identified in the cookie against security data held by in the respective database 60 or 100. Once the policy server 80 or 90 has validated the user's token against the authentication data held by the respective database 60 or 100 (i.e. established the identity of the user), it exploits a mapping to locate authorization data corresponding to the authenticated user and also stored in the same data base. Once the authorization data is located, a set of profile attributes including a username and authorization status are returned from database 60 or 100 to the policy server 80 or 90, as the case may be. The policy server 80 or 90 returns the profile attributes to the respective web agent 32 or 42.

An attempt by the advisor in the nat.bt.com domain to access directly a secure resource in the bt.com domain would not be supported by the advisor's nat.bt.com browser 20. This results from standard network security features implemented, in this example, by the nat.bt.com Siteminder policy server 90 by means of cookies, as explained below.

The advisor 20 logs in to the nat.bt.com domain in conventional manner, interacting with a Siteminder policy server 90 which authenticates the advisor. As detailed above, successful authentication of the advisor with the Siteminder policy sever 90 will result in the advisor being issued, by the Siteminder web agent 42, with a cookie identifying the advisor and other data which is stored by the advisor's browser 20. Included in the other data stored on the advisor's browser 20 is a copy of an identifier of the domain (the “cookie domain”) to which the advisor's browser is authenticated (i.e. the nat.bt.com domain). This identifier will normally be set to the local domain name (or part thereof). The cookie is deemed valid by the browser if there is a tail match between the domain name of the web server contained in the request and the cookie domain recorded in the browser—in the present example, this tail could be “nat.bt.com”. Hence the web browser of the advisor authenticated against the nat.bt.com domain will not send a copy of the cookie with a request for access to a resource that is identified (by the resource URI) as located in the bt.com domain. This will result in the user not being deemed authorized which could result in rejection of the request.

According to the invention, two URIs will be published for the F&F application (e.g. www.bt.com/appn/customer for consumers and volcrm.nat.bt.com/appn/advisor for advisors). As described in more detail, below, creation of this pair of URIs advantageously allows access to a single web application by a wider user-base by creating the effect of two separate applications.

According to the invention, the nat.bt.com web server 40 comprises a reverse proxy plug-in 110 which is configured to publish the remote resource (i.e. the “consumer” F&F web application) in the nat.bt.com domain. The resource is published in such a way as to make it seem to the advisor's browser 20 that the remote resource is hosted locally, thus making the remote resource available to the advisor authenticated against the nat.bt.com domain. This is achieved by the reverse proxy publishing a “fake” URI for the resource, e.g. volcrm.nat.bt.com/appn/advisor. The URI published by the reverse proxy is fake, in that it identifies the nat.bt.com domain (the local domain for the advisor), rather than the bt.com domain (the domain on which the resource is actually hosted).

When the advisor issues a request from the advisor's browser 20 to the nat.bt.com web server 40 for access to the resource, the request quotes the “fake” URI for the remote resource published by the reverse proxy 110. Reverse proxy 110 monitors HTTP traffic to the web server and picks out, according to a reverse proxy rule determined upon configuration, messages relevant to the remote resource by identifying references in the messages to the desired resource identifier—e.g. “/fnf”. The reverse proxy replaces the “fake” (e.g. volcrm.nat.bt.com/appn/advisor) URI in the request for the remote resource with the true URI (e.g. www.bt.com/appn/advisor) and directs the request via the firewall (not shown) to the consumer web server 30 operating in the bt.com domain. The bt.com web server has a Siteminder web agent 32 to handle the request received from the reverse proxy, so the request is authorized a second time when it is received by the bt.com web server 30. This second authorization is performed using a second bt.com Siteminder policy, as described below. Once authorized, the bt.com web server treats the request as any other valid request it might receive from a local user (such as the consumer) and forwards it via proxy plug-in 34 towards the requested resource, in this case the consumer F&F web application on server 50.

Responses to the advisor's request from the consumer F&F web application are returned to the remote user, i.e. the advisor, via proxy plug-in 34 and web agent 32 on the consumer's bt.com web server 30 and reverse proxy 110 on advisors web server 40 by using the source address contained in the request.

In the conventional arrangement, the web browser 40 of the advisor authenticated against the nat.bt.com domain will not send a copy of the cookie with a request for access to a resource that is identified (by the resource URI) as located in the bt.com domain. Without the appropriate cookie, the request will be rejected by the policy server 80. The invention overcomes this restriction by arranging for the reverse proxy to publish the remote application with a modified URI for the resource, specifically a URI that identifies the local domain.

According to a further embodiment, consumer and advisor policy servers 80, 90 share the same keys 120 for encryption of data included in the cookie. In an alternative embodiment, a single policy server may be used to support both consumer and advisor.

In addition to the normal, bt.com consumer authentication and authorization Siteminder policy, a bt.com employee authentication and authorization Siteminder policy is provided to handle requests received by bt.com web server 30 from the advisor user operating in the nat.bt.com domain. This additional policy will be configured with the corporate database 100 using the same web agent 32 as the existing bt.com policy. In normal operation, the advisor will already be authenticated and authorized before any HTTP requests arrive from the advisor at the bt.com web agent 32 and, therefore, the bt.com web agent 32 only needs to verify and authorize the advisor according to the additional policy. Consumer users will continue to be dealt with under the existing bt.com policy using information in bt.com database 60. The additional Siteminder policy is implemented as a policy domain object.

Existing bt.com applications will only support bt.com authenticated users (i.e. not users authenticated using the corporate directory) however, an advisor that happened to know the bt.com URI for the F&F resource could in theory gain direct access and be authenticated by the bt.com authentication and authorization authority on the basis of their corporate credentials. This would result in the creation in the bt.com domain of a cookie based on the corporate credentials which could provide undesirable access for the advisors to other areas of bt.com. To prevent this, a software load balancer (such as the ZXTM Zeus Extensible Traffic Manager from Zeus Technology) is used to filter out unwanted access attempts so as to prevent advisors directly accessing the F&F application from the bt.com front end.

Preferably, the reverse proxy traffic between the two web servers is encrypted to protect the privacy of the advisors.

The invention, in the embodiment described above, provides secure, single sign-on access for advisors from the CRM resource to the F&F resource. Although described with reference to the BT F&F application, the invention has wide applicability to applications both within and external to BT. For example, for the general public to access secure internal applications.

Although described with reference to two classes of user operating in two different domains with two different authentication directories, the skilled reader would appreciate that the invention is equally applicable to systems with three or more classes of user operating in three or more domains with three or more different authentication directories. Although described, for clarity, with reference to a single advisor user and a single consumer user, the skilled reader will appreciate that the invention applies, and will normally be applied to, an arrangement with a plurality of advisor users and associated browsers together with a plurality of consumer users and associated browsers. The invention not limited to an external and an internal domain but has application in resource access between two domains operating on the same side of a firewall or with no firewall.

In particular, the skilled reader would appreciate that the databases or authentication and authorization directories could be implemented as LDAP, relational or other, proprietary, structure without diverging from the scope of the present invention. Although embodiments have been described with reference to the Siteminder system, the skilled reader would appreciate that the invention has application to other forms of identity assertion system.

As will be understood by those skilled in the art, the invention may be implemented in software, any or all of which may be contained on various transmission and/or storage mediums such as a floppy disc, CD-ROM, or magnetic tape so that the program can be loaded onto one or more general purpose computers or could be downloaded over a computer network using a suitable transmission medium. The computer program product used to implement the invention may be embodied on any suitable carrier readable by a suitable computer input device, such as CD-ROM, optically readable marks, magnetic media, punched card or tape, or on an electromagnetic or optical signal.

Those skilled in the art will appreciate that the above embodiments of the invention are greatly simplified. Those skilled in the art will moreover recognise that several equivalents to the features described in each embodiment exist, and that it is possible to incorporate features of one embodiment into other embodiments. Where known equivalents exist to the functional elements of the embodiments, these are considered to be implicitly disclosed herein, unless specifically disclaimed. Accordingly, the spirit and scope of the invention is not to be confined to the specific elements recited in the description but instead is to be determined by the scope of the claims, when construed in the context of the description, bearing in mind the common general knowledge of those skilled in the art.

The content of the attached abstract is incorporated herein, as follows: a system for providing secure access to a resource hosted in a first domain, comprising a first web server for providing access to the resource. A second web server is provided in a second domain for receiving requests from a user for access to the resource. A browser is arranged for authentication and authorization for access to resources in the second domain and for forwarding requests from the user to the second web server. A reverse proxy is provided for publishing, with a resource identifier identifying the second domain, the resource to the second web server. The reverse proxy is arranged to forward to the first web server for access to the resource requests received from the second browser.

1. A system for providing secure access to a resource hosted in a first domain, in which the first domain comprises a first web server for providing access to the resource, said system comprising:
a second web server for operating in a second domain for receiving requests from a user for access to the resource;
a browser arranged in use to be authenticated and authorized to access resources in the second domain and to forward requests from the user to the second web server; and
a reverse proxy for publishing, with a resource identifier identifying the second domain, the resource to the second web server.

2. A system as claimed in claim 1 in which the reverse proxy is arranged to forward to the first web server for access to the resource requests received from the second browser.

3. A system as claimed in claim 1 in which the request comprises a resource identifier specifying the second domain and the reverse proxy is arranged in use to replace the resource identifier received with the request with a resource identifier specifying the first domain.

4. A system as claimed in claim 1 in which the reverse proxy is a plug-in to the second server.

5. A system as claimed in claim 1 in which the first domain comprises a policy for supporting access from the second domain.

6. A system as claimed in claim 1 in which the policy is arranged to access user information from a database also accessible from the second domain.

7. A system as claimed in claim 1 in which the policy is arranged to use user information also used by a policy in the second domain.

8. A system as claimed in claim 1 comprising filter means for blocking access to the resource by a user in the second domain using a resource identifier identifying the first domain.

9. A reverse proxy for a second domain for providing a secure access to a resource hosted in a first domain, in which the reverse proxy is arranged in use to:
publish the resource in the second domain with a resource identifier identifying the second domain;
receive a request specifying the resource identifier from a user in the second domain for access to the resource;
replace in the request the received resource identifier with a resource identifier identifying the first domain; and
forward the requests to the first domain.

10. A method of securely accessing from a second domain a resource in a first domain, the method comprising:
publishing the resource in the second domain with a resource identifier identifying the second domain.

11. A method as claimed in claim 10, further comprising:
receiving a request specifying the source identifier from a user in the second domain for access to the resource;
replacing in the request the received resource identifier with a resource identifier identifying the first domain; and
forwarding the request to the first domain.

12. A method as claimed in claim 10 further comprising setting up a policy in the first domain to support access from the second domain.

13. A method as claimed in claim 10 in which the policy accesses user information from a database also accessed from the second domain.

14. A method as claimed in claim 10 in which the policy uses user information also used by a policy in the second domain.

15. A method as claimed in claim 10 further comprising blocking access to the resource using a resource identifier identifying the first domain by a user in the second domain.

16. A method as claimed in claim 10 further comprising differentiating the resource identifier identifying the first domain from a third resource identifier identifying the first domain for access to the resource from the first domain.

17. A computer-readable storage medium containing a computer program or suite of computer programs which, when executed by one or more computers, performs the method steps as set out in claim 10.
